(19) United States
(12) Patent Application Publication
(10) Pub. No.: US 2008/0071698 A1
(43) Pub. Date: Mar. 20, 2008

(54) System and method for an indexed mutual fund

(75) Inventors: Michael S. Midlam, Rancho Santa Fe, CA (US); Daniel R. Patterson, Encinitas, CA (US)

Correspondence Address: TERRANCE A. MEADOR;INCAPLAW, 1050 ROSCRANS STREET, SUITE K, SAN DIEGO, CA, 92106, US

(73) Assignee: Asset Marketing Systems Insurance Services, LLC, San Diego, CA (US)

(21) Appl. No.: 11/514,623

(22) Filed: Sep. 1, 2006

(51) Int. Cl. G06Q 40/00

(52) U.S. Cl. 705/36 R

(57) ABSTRACT

An indexed mutual fund management system and a method for managing such a fund calculate, based on a fund time T, a value of fixed income assets and a value of derivative assets such that the sum of the value of fixed income assets and the value of derivative assets equals an initial mutual fund principal amount at a mutual fund closing time, calculate a hedging strategy over the fund time based on the value of derivative assets related to an index, transmit one or more orders for investment of a portion of the fund principal equal to the value of fixed income assets, and transmit one or more orders for investment of a portion of the fund principal equal to the value of derivative assets according to the hedging strategy. The system and method may calculate a cap for the indexed mutual fund based on the value of derivative assets related to an index, in which case the hedging strategy may be calculated over the fund time based on the cap. Periodically, the hedging strategy is recalculated using parameters selected to implement a particular investment strategy and/or to respond to short-term changes in a market in which the derivative assets are traded.

### BACKGROUND OF THE INVENTION

The field is management of financial instruments. More particularly, the field concerns a system and a method for an indexed mutual fund.

It is known to hedge an investment against loss. In this regard, one may determine an investment strategy that promises, over a period of time, to return a value equal at least to the initial investment, if not the initial investment plus an additional amount. In order to support the objective of recovering at least the initial investment at the end of the period of time (“the investment period”), it is known to apportion the initial investment between a first amount to be invested in fixed assets (assets providing a fixed return over the period of time) and a second amount to be invested in volatile assets (assets whose values will probably vary over the period of time) subject to at least three considerations. First the sum of the first and second amounts must initially equal the initial investment. Second, the value of the fixed return at the end of the period of time should equal the amount of the initial investment. Finally, the second amount is invested in a way to hopefully produce a net increase in the second amount by the end of the period of time. Investment of the second amount is typically implemented by means of a hedging strategy.

The hedging strategy may utilize a forward-looking mathematical model of some selected market to determine current prices for certain products sold in the market, based upon a forecast of values of those products at some future time. Once the prices are determined, the products are bought and held for disposition at the future time. For example and without limitation, in a selected market in which derivatives are traded, the products may include calls, puts, long contracts, and short contracts. In addition, a portion of the second amount may be deposited in short term interest bearing accounts. If the market actually produces values for the products that are less than those forecast, the hedging strategy may be adjusted to recover the loss and then applied to the remainder of the second amount. In this manner, under extremely volatile market conditions that deviate from the model, the hedging strategy may ultimately consume the entire second amount by the end of the investment period. In this circumstance, the value of the investment of the first amount in assets with fixed returns should equal the amount of the initial investment. However, under normally-varying market conditions, hedging strategies can produce positive returns by the end of the investment period that, when added to the fixed return, result in a positive growth in the initial investment.

If the hedging strategy requires an amount greater than the second amount, such as when the model predicts certain volatility in the selected market over a particular period and the actual volatility is less than predicted, additional assets might be required to implement the strategy. If the second amount is not great enough to implement the hedging strategy, some assets in the first amount may have to be liquidated and provided to the second amount in order to meet the shortfall. Alternatively, funds may be borrowed for the same purpose for short periods. If short term interest rates rise, the expense of borrowing and the amount required for the hedging strategy increase. In order to reduce such risks, the model may utilize means to limit the amount required to implement the hedging strategy one example of a limit is a cap. A limit on return, such as a cap, may be used by a hedging strategy to guard against factors that unpredictably increase the hedging investment requirements. Such factors include, for example and without limitation, reductions in market volatility and increases in short term interest rates.

Certain annuities may utilize hedging models for the purposes described above. An annuity is a contract between an annuitant, typically an individual and an annuity provider, such as an insurer. Under the annuity contract, the annuitant pays one or more premiums and the provider agrees to make at least one payment during the life of some person or group of persons. In an indexed annuity, some returns are determined with reference to one or more indexes. These returns may be denoted as “index-based” gains. An index that is used to determine gains credited to an indexed annuity is said to “underlie” or to be “linked to” the annuity. More than one economic index or reference may be used to determine the index-based gains of an indexed annuity. The index-based gains may be the only returns added to the annuity's value, or they may be in addition to interest and/or bonuses. Index-based gains are determined with reference to a term of time, an index term, with the gains credited to the accumulation value of the annuity periodically during the index term or once at the end of the index term. The index term may be one or more years, measured from the date of the annuity contract. A typical index term, for example, is a “policy year” measured from the anniversary date of the annuity contract. Various methods are used to calculate the index-based gain over the index term. For example, an index-based gain may be based on the difference between the value of an index at the beginning and end of the term. Or, the gain may be based on periodic changes in the value of the index. In this regard, an annual index-based gain may be derived from the percentage increase in an index on which the annuity is based. An indexed annuity may be subject to a participation rate, that is to say, a percentage of the index-based gain calculated for the term. For example, if the index increases 8% over the term and the participation rate is 85%, the index-based gain could be calculated as 6.8%. Many indexed annuities are subject to a cap on the index rate. A limit, such as a cap, may be applied periodically during or over a term. Thus, if the annual limit in the previous example is 6%, then 6% will be credited to the annuity instead of 6.8%. The annuity contract may enable the provider to change the limit. For example, an insurer may be allowed to reset a cap at the end of the policy year.

The usual objective of an indexed annuity is to guarantee pay out of the annuity's principal, that is, the premium value initially paid by the annuitant. It is known to apply a hedging strategy to provide the possibility of gains resulting from growth of the underlying index. One such annuity is the MasterDex 5® Annuity sold by the Allianz Life® insurance company. In such an annuity, the hedging strategy may used to periodically calculate hedging strategy parameter values between annuity anniversaries. If necessary, the cap may be reset annually at the policy year anniversary. However, limiting cap variability to annual increments makes the hedging strategy vulnerable to increased costs resulting from short term changes in market volatility and increases in short term interest rates in any year during which the cap is constant.

A mutual fund is a financial product in which investors pool money to achieve a particular investment objective. The money is managed by a fund manger authorized and empowered to invest the pooled money so as to achieve the desired objective. In a closed mutual fund, investors place money in the fund and each investor receives fund shares in an amount representing the proportion that the investor's investment bears to the total amount of money invested in the fund. When a closed mutual fund is initiated, its objective and an initial fund size are announced by the fund manager. The fund is then declared open. Investments are invited and accumulated. When either a predetermined time has passed or when the aggregate of the investments reaches the announced fund size, the mutual fund is closed to further investment and the fund manager invests the pooled investments according to the announced objective. Mutual funds that are organized for participation by the public are regulated at the Federal level under the Investment Company Act of 1940 (“the ICA”). According to the ICA, such mutual funds must register their shares with the Securities and Exchange Commission (“the SEC”). The SEC is then responsible for oversight and regulation of the funds' public statements and internal management. Certain types of privately-offered mutual funds are exempted from regulation under the ICA, although they may be subject to other Federal and/or state regulations.

Indexed annuities guaranteeing protection of the original premium price are popular financial products for individuals seeking the privacy, certainty and stability of an enforceable contract between an annuitant and the annuity provider. Capping the participation in the index provides both the annuitant and the insurer an objective, agreed limit on the scope of the hedging strategy. However, the combination of capping and hedging used in annuities does not easily translate to other financial products such as mutual funds because of differences in financial structure, underlying actuarial principles, parties, and legal principles of contract law, and also because of different schemes of Federal and state regulation. Further, the relatively long period between cap adjustments emphasizes protection of the annuity premium but exposes such annuities to risks posed by short term market factors such as reduced volatility and/or increased short term interest rates. It would be desirable to apply a hedging strategy to financial products such as mutual funds in order to support the offering and management of an indexed mutual fund that would serve one or more objectives. Such objectives may include, for example and without limitation, emphasis on principal protection and/or emphasis on participation in gains of the underlying index. Moreover, a desirable flexibility in the management of such funds would permit adaptation of a hedging strategy to support selected fund objectives. Further, frequent short term recalculation of the cap would enable the mutual fund manager to respond quickly to sharp, fast changes in market volatility and short term interest rates, thereby affording a closer tracking of market activity with faster response to market changes than obtainable in annuity hedging.

Setting parametric relations of a hedging calculation in order to implement a hedging strategy that favors one or more investment objectives would produce the technical effect of shortening processing time to produce a revised hedging strategy should the chosen objective change. For example, an adaptable hedging strategy may utilize a hedging calculator with means for establishing first parametric relations favoring preservation of principal and for changing the first parametric relations or establishing second parametric relations to favor participation in returns of an underlying index in response to observable data reporting market conditions.

### SUMMARY

An system a method for managing an indexed find calculate, based on a fund time, a value of fixed income assets and a value of derivative assets such that the sum of the value of fixed income assets and the value of derivative assets equals an initial mutual fund principal amount at a fund closing time, calculate a hedging strategy over the fund time based on derivative assets related to an index, transmit one or more orders for investment of a portion of the fund principal equal to the value of fixed income assets, and transmit one or more orders for investment of a portion of the fund principal equal to the value of derivative assets according to the hedging strategy. Periodically, the hedging strategy is recalculated using parameters selected to implement one of a plurality of investment strategies and/or to respond to short-term changes in a market in which the derivative assets are traded. The system and method may also calculate a return limit such as a cap for the indexed mutual fund, and calculate the hedging strategy over the fund time based on the cap.

### BRIEF DESCRIPTION OF THE DRAWINGS

FIG. 1 is a block diagram showing a system with financial components that cooperate to enable production and management of an indexed mutual fund.

FIG. 2 is a block diagram of a fund management system for the system of FIG. 1.

FIG. 3 is a block diagram illustrating an investment system for managing an indexed mutual fund.

FIG. 4 is a flow diagram illustrating an investment method for managing an indexed mutual fund.

FIG. 5 is a chart representing one-month forward values of an exemplary calculated hedging strategy.

### DETAILED DESCRIPTION OF THE PREFERRED EMBODIMENTS

An indexed mutual fund characterized by an initial fund principal, a fund strategy, and a fund period is managed by calculating an initial allocation of the fund principal amount into fixed and hedging amounts, and calculating an initial hedging strategy. One or more orders are transmitted for investment of the fixed amount in assets with long term fixed yields, and one or more orders are transmitted for investment of the hedging amount in assets with short term yields determined by market activity. The hedging strategy may be recalculated to accommodate short term changes in market volatility and/or interest rates. The fund may further be managed by calculating an initial cap and calculating the initial hedging strategy based on the initial cap. Both the cap and the hedging strategy may be recalculated to accommodate short term changes in market volatility and/or interest rates.

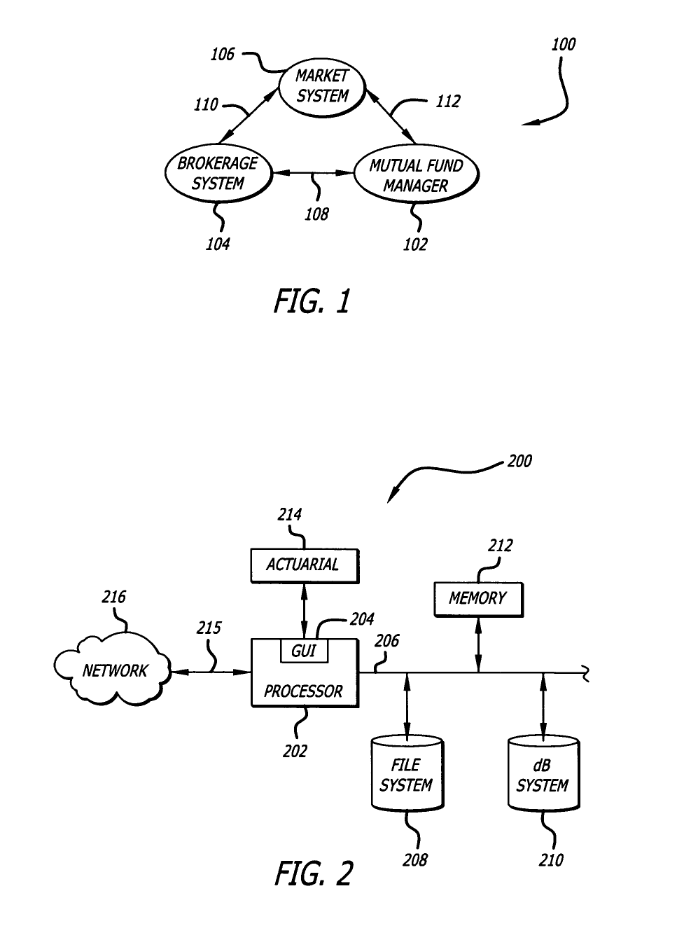

As shown in FIG. 1, the functions and acts that are set forth in this specification may be implemented in a system 100 constituted of one or more enterprise computing systems, including, for example and without limitation, a mutual fund management enterprise system 102, a securities brokerage enterprise system 104, and at least one market enterprise system 106. The mutual fund management enterprise system 102 and the brokerage enterprise system 104 are linked to conduct automated financial transactions by a communications link 108; the brokerage enterprise system 104 and the at least one market enterprise system 106 are linked to conduct automated securities transactions by a communications link 110; the mutual fund management enterprise system 102 and at least one market enterprise system 106 are linked to provide financial and market information to the mutual fund management enterprise system 102 by a communications link 112. The communications links 108 and 110 include interface and communications resources for formatting and communicating transaction information, while the respective enterprise systems that they link include processing resources for conducting financial and securities transactions by means of the transaction information communicated therebetween. The communications link 112 includes interface and communications resources for formatting and communicating market and financial information.

The mutual fund management enterprise system (“manager”) 102 includes a mutual fund management and transaction system; the brokerage enterprise system (“brokerage”) 104 includes a securities transaction system; and the at least one market enterprise system (“market”) 106 includes a securities trading system and, typically, a financial reporting service. The manager 102 and the brokerage 104 are typically distinct enterprise system entities that conduct financial transactions whereby the brokerage 104 maintains various investment portfolios and conducts various securities transactions with respect to those portfolios in response to orders from the manager 102, and reports portfolio activity to the manager. The at least one market 106 may have an integral brokerage component, such as a seat on an exchange possessed by the brokerage 104. The market 106 provides the brokerage 104 with access to automated trading of securities. The market 106 also has or has access to a financial and market information system from which subscribers including the manager 102 obtain information relating to economic, market and financial activity.

A system for managing an indexed mutual fund may be a general purpose computer system programmed to execute procedures and functions to be described below. A method for managing an indexed mutual fund may be implemented in a software program embodied in an Excel spreadsheet or written in the C++ and/or Java programming languages. Of course, the programmed computer system and the method may also be embodied in a special purpose processor provided as a set of one or more chips. Further, there may be a program product constituted of a program of computer instructions stored on a tangible article of manufacture that cause a computer to execute the method. The tangible article of manufacture may be constituted of one or more portable storage devices such as magnetic or optical disks or it may be constituted of one or more nodes in a network.

FIG. 2 illustrates a system 200 for managing one or more indexed mutual funds so as to obtain possible returns derived from changes in the value of an underlying index, preferably increases in the value. The operations performed by the system 200 constitute a method for management of the indexed mutual fund. The system 200 is implemented in processing architecture integrated into the enterprise computing system of a mutual fund manager, for example the manager 102 of FIG. 1. The specific implementation of the manager's enterprise computing system is a matter of design choice by the reasonably skilled artisan. Nevertheless, the system 200 may entail a centrally-controlled computer system, a server-based system, a work station, a desk top computer, or an internet service computing system with the capability of communicating externally of the manager with one or more brokerages and/or markets. The system 200 includes processing, graphical user interface (GUI), bus, file, database and memory components, 202, 204, 206, 208, 210, and 212, that receive input information, conduct calculations and transactions, transmit, store, and retrieve information within the system 200, conduct exchanges of information with one or more brokerages, issue orders, and cause the receipt, transfer and aggregation of bonds, certificates, accounts, securities, derivatives, and interest. The system 200 is operated by one or more authorized users such as, for example, an actuary 214. The system 200 is enabled by a network connection 215 to access external systems via a network 216. Such external systems may include one or more brokerage and market enterprise systems such as described above. The system 200 is designed and programmed to:
receive and process actuarial, economic, financial and market information;
manage and administer mutual funds, including indexed mutual funds;
receive and process mutual fund principal;
conduct investment transactions with one or more brokerages;
calculate caps;
calculate hedging strategies;
issue orders to brokerages for fixed asset transactions; and
issue orders to brokerages for hedging transactions.

Although the system 200 is illustrated and described in terms of a single index, the intent is to show the system at its most elemental level in order to foster a clear understanding of how it works. In practice, a mutual fund manager could employ means to apply the system 200 to more than one index.

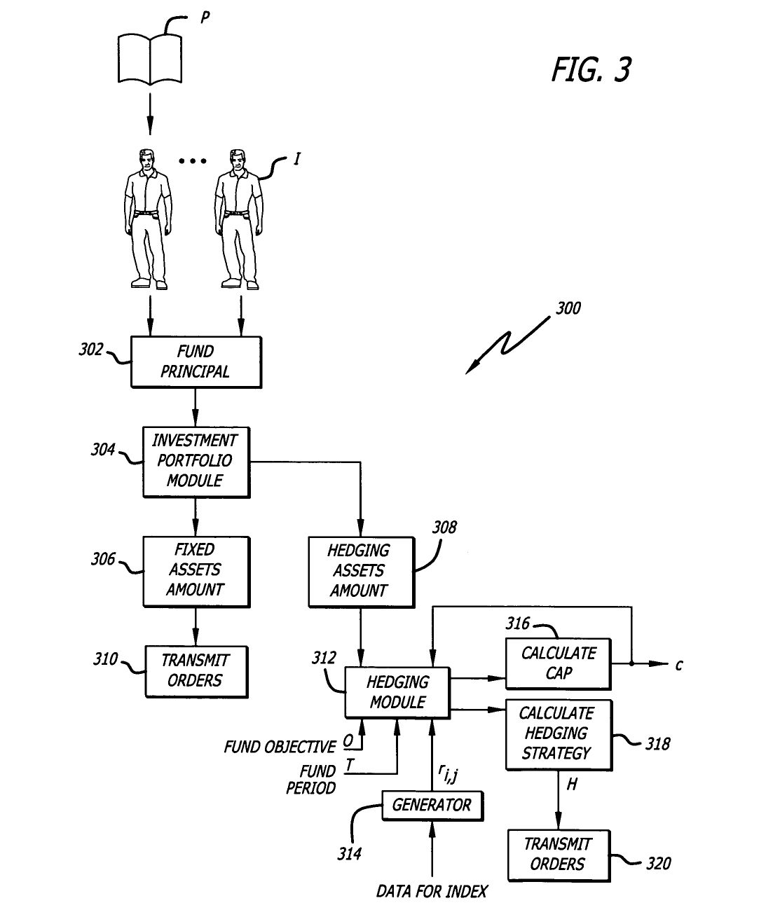

The system 200 includes one or more processing modules embodied in one or more computer programs, files, and data distributed among elements of the system 200. Certain of those modules constitute an investment system 300 illustrated in FIG. 3. Connections between the modules represent data and/or control transferred between modules either unidirectionally or bidirectionally. In the description, such data will be referred to in terms of information that it represents. In FIG. 3, when the fund is opened, the fund manager publishes for potential investors a prospectus P for an indexed mutual fund, for example, a closed mutual fund. The prospectus P may set forth, among other things, a fund objective, an index to which the fund is linked, a minimum investment, a target fund principal amount, and a fund time or period T at the expiration of which some event (such as distribution of fund assets plus any gains from appreciation of an index) will occur. The prospectus may provide for changing the fund objective during the term of the mutual fund under defined conditions. One or more fund investors I invest in the indexed mutual fund. When investment in the fund is closed, a fund principal amount representing the sum or aggregate of the individual investments is determined. The fund principal amount 302 is received by an investment portfolio module 304. Based upon an allocation process, the investment portfolio module 304 functions as an initial portfolio calculator to divide the fund principal into amounts for investment in fixed assets 306 and hedging assets 308. The fixed assets amount is designated for investment in one or more fixed assets whose book yields are known. Such fixed assets may comprise, for example and without limitation, bonds, contracts, and/or money market accounts and other forms of deposit bearing fixed rates of return over designated periods of time. If a fund objective is preservation of the fund principal, the investment portfolio module 304 determines a fixed asset amount that will, when invested in fixed assets, produce a return equal to the fund principal amount at the expiration of T. One or more orders for investment of the fixed asset amount may be transmitted to a brokerage by a data transmitter 310.

Continuing with the description of FIG. 3, the hedging asset amount 308 produced by the investment portfolio module is input to a hedging module 312 together with data S indicating a selected fund strategy, a value indicating a fund period T, and data for selected objective market parameters. The selected objective market parameters used by the hedging module constitute the link that ties the mutual fund to the underlying index. Optionally, the selected market parameters may include, for example and without limitation, derivatives based upon the underlying index. Such derivatives may include, by way of further example, European options (calls and puts exercised only on the day the options expire) on the underlying index. Data regarding such parameters may be obtained, for example, in the form of daily prices for European options in one or more selected derivatives from a market enterprise system such as the Chicago Board of Trade. One may generate sets of forecast returns r_{i,j} (such as forecast values for European options) by subjecting the data for a current objective market parameter (such as a daily European option price on a derivative of the index) to a generator 314 whose operation is based on some assumption about how option prices change during a short time period, say one month from the date of a current European option price. For example and without limitation, the generator 314 may be constituted of a log normal generator. The sets of forecast returns r_{i,j} are provided to the hedging module 312.

With further reference to FIG. 3, using the inputs described above, the hedging module 312 uses a cap calculator 316 to calculate a cap and a hedging calculator 318 to calculate a hedging strategy. With the hedging strategy, the mutual fund management system 200 is enabled by a data transmitter 320 to transmit orders to a brokerage for derivative transactions that implement the hedging strategy.

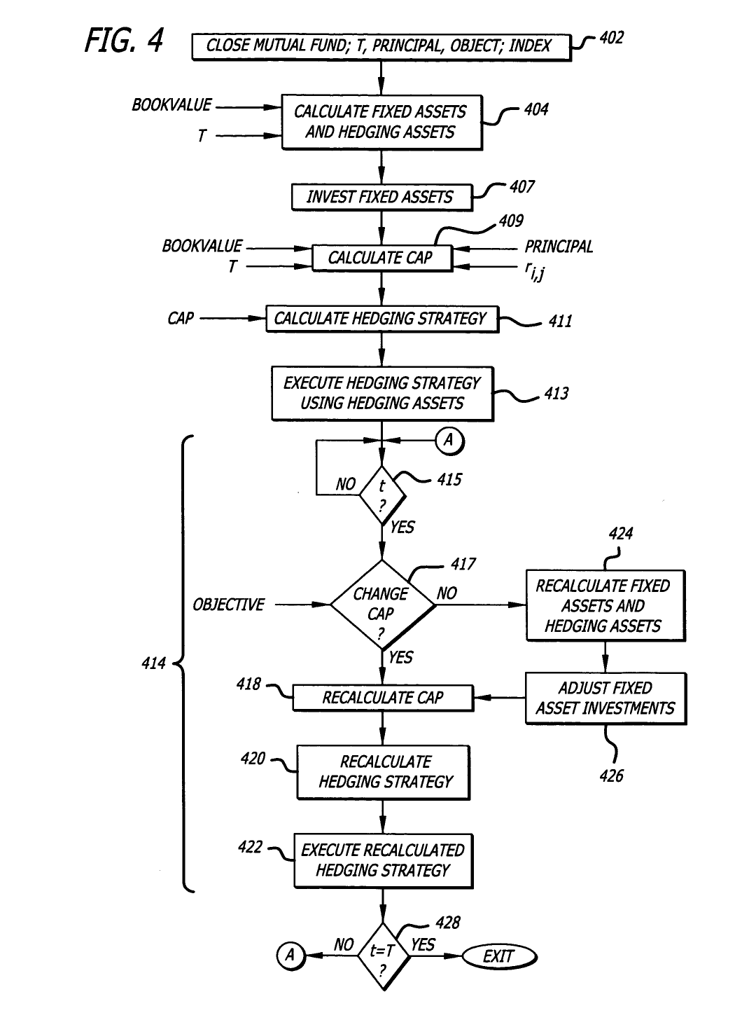

An investment method 400 for an indexed mutual fund is illustrated by the flow chart of FIG. 4. The example presumes the use of a cap to limit the amount of return, although this may not be necessary to the practice of the invention. In this regard, the method may use one or more additional, or other, limits, or no limits. The flow chart represents one or more computer programs and/or processor functions that enable the system 200 of FIG. 2 to manage an indexed mutual fund. In step 402, an indexed mutual fund is closed and a time T, a fund principal amount (“fund principal”), a fund objective, and a fund index are known. In step 404, with a present book value of fixed assets and T as inputs, the fund principal is apportioned between a fixed income asset amount and a hedging asset amount such that the sum of the fixed income asset amount and the hedging asset amount equals the fund principal. The fund income asset amount is invested at step 407 in fixed return assets such that, at T, the present book value of the fixed return assets will at least equal the fund principal amount. In step 409, a cap c is initially calculated using the present book value, T, the fund principal amount and the forecast returns rig of at least one derivative on the index. Then, using the initially-calculated cap c, a hedging strategy is initially calculated in step 411, and the hedging strategy is executed using hedging assets in step 413. Following these steps, the method 400 periodically executes a short term loop 414 to recalculate the hedging strategy and, depending on the selection of a fund objective, the cap c. The short term loop is entered through decision 415 that tests the elapse of time against a time period ti, where i is an integer having a value of from 0 to T. Preferably, t>>T (very much less than T). For example t may equal one month and T ten years. In fact t may measure any time period that is very much less than T, for example a 24-hour period (one day). During t, preferably, when t has elapsed, the short term loop in step 417 responds to the selected objective to determine whether or not to recalculate the cap c. For example, if preservation of the fund principal amount is emphasized the cap is recalculated. If the cap is to remain constant, the negative exit is taken from decision 417. Otherwise, the method 400 proceeds through the positive exit from the decision 417 and recalculates the cap in step 418. The method 400 recalculates the hedging strategy in step 420 with either the recalculated cap or the initial cap and executes the recalculated hedging strategy in step 422. Through decision 428, the method 400 periodically transitions through the short term loop 414 until t=T, at which time the method 400 is completed and fund assets may be distributed to the investors. Preferably, when principal preservation is the objective, the method 400 in step 424 recalculates the fixed and hedging assets (as in step 404, with an updated book value) and, in step 426, makes any adjustments to the fixed asset investments required by the recalculation in step 424. In this case, the method transitions from step 426 to step 420.

### INDUSTRIAL APPLICATION

To better understand how the system 200 and the method 400 operate to manage an indexed mutual fund, consider the following industrial application embodied as an exemplary pseudo-coded program. In this example, the hedging strategy is implemented in derivatives of an underlying index and so is called a derivative strategy in which the hedging assets are derivative assets. The following definitions apply:

Fund Horizon (T): A period of time to the occurrence of a defined event.

Book Yield (BYₜ): The underlying yield of the fixed income assets assuming the assets are held until maturity at time t.

Fund Principal: Fund Principal is the aggregate amount of the initial investments of all investors at the close of the fund (example: $450,000,000).

Upside Cap (UCt): The stated upside cap (also called “the cap”) of the fund at time t. The cap defines how the fund's derivative strategy will be managed. Preferably, although not necessarily, the cap may be a monthly cap, which would limit the monthly upside return potential.

Objective Market Parameter (MP): An objectively-determined parameter linked to a selected index that enables scenario sets to be calibrated to some market for derivatives of the index. The value of this parameter may be periodically determined by observation of a defined market indicator, or by calculation from basic market parameters. For the following explanation, the objective market parameter is an index and the values for the parameter are the observed market prices of European monthly options on some index, although this in no way limits the described process. For example, the Chicago Board of Trade provides daily prices for European options on the Standard & Poors S&P500® index under the symbol SBX. In the following example, options for the selected index are referred to as “embedded options” and their values are denoted as “embedded option values”. Forecast returns r_{i,j} for the embedded options are utilized in the calculations to be described, in which i is an integer denoting a scenario and having values from 1 to N and j is an integer denoting a time period and having values from 0 to T.

At fund closing (time 0), the investment portfolio module apportions the fund principal amount according to Function 1 and the hedging module calculates an initial cap c and an initial hedging strategy according to functions 2 and 3:

### Function 1—Determine Fixed Income Assets and Derivative Trading Assets

Inputs: [BY₀, Fund Principal, T]

Outputs: [FIA₀, Fixed income assets at close of fund, and DA₀, Derivative Assets at close of fund-the hedging asset amount initially used to implement a hedging strategy]

Using BY₀, the investment protfoliomodule identifies FIA₀ at time₀ (close of the fund) that will equal the initial Fund Principal at time T, assuming the following:

$${FIA}_{0} = \frac{Fund Principal}{{( 1 + B {Y}_{0} )}^{T}}$$

The remaining fund assets at the close of the fund, DA₀, are given as:

DA₀=Fund Principal−FIA₀

Using FIA₀, one or more orders for fixed assets are transmitted. Then the hedging module calculates an initial cap c in step 2:

### Function 2—Determine an Initial Cap

Inputs: [DA₀, BY₀, r_{i,j}]

Outputs: [UC₀ (Initial Cap)]

Define (EOVt,c), as the embedded option value of a capped monthly sum derivative embedded in the fund at time t, assuming a monthly cap of c in each month until time T.

Set an initial value of UC₀ to force EOV₀,c to equal DA₀, and set c=UC₀;

DO the following iterative process to determine c and EOVt,c, modifying c until EOVt,c equals DA₀:

i. Denote {S₀} to be a scenario set of N random monthly return scenarios at the close of the fund (time₀) calibrated to some selected objective market parameter. For this example, but without limitation, the scenario set {S₀} is constructed to replicate observed market prices of European monthly options at close of the fund

ii. Each scenario Si in {S₀}, i=1 to N, forms a vector of (T×12) monthly random index returns. Each monthly random index return will be denoted r_{i,j} for i=1 to N,j=1 to (T×12)

iii. For each scenario Si, there is a value EOVt,c,i which represents the value of an option under the particular random paths, i=1 to N, for particular value of c. Determine EOVt,c,i by the following recursion:

Step 1:

Choose a particular value of c for a starting point

Step 2:

Denoting Fund Principal as FP, determine:

$${EOV}_{0} , c , i = FP \times [ max [ ( min ( {r}_{i , 1} , c ) + min ( {r}_{i , 2} , c ) + min ( {r}_{i , 3} , c ) … + min ( {r}_{i , 12} , c ) + 1 ) , 1 ] \times max [ ( min ( {r}_{i , 13} , c ) + min ( {r}_{i , 14 ,} c ) + min ( {r}_{i , 15} , c ) … + min ( {r}_{i , 24} , c ) + 1 ) , 1 ] \times max [ ( min ( {r}_{i , 25} , c ) + min ( {r}_{i , 26} , c ) + min ( {r}_{i , 27} , c ) … + min ( {r}_{i , 36} , c ) + 1 ) , 1 ] \times … \times max [ ( min ( {r}_{i , ( T \times 12 - 11 )} , c ) + min ( {r}_{i , ( T \times 12 - 10 )} , c ) + min ( {r}_{i , ( T \times 12 - 9 )} , c ) … + min ( {r}_{i , T \times 12} , c ) + 1 ) , 1 ] - 1 ]$$

Then, after EOV_{0,c,i} is calculated for each i; i=1 to N, EOV_{0,c} is defined to equal the average of all EOV_{0,c,j}; i=1 to N

Step 3

$${EOV}_{0 , c} = ( {EOV}_{0 , c , 1} + {EOV}_{0 , c , 2} + {EOV}_{0 , c , 3} + … + {EOV}_{0 , c , N} ) / ( \frac{N}{{( 1 + B {Y}_{0} )}^{T}} )$$

Iterate steps 2 and 3 using a different c for each iteration, until EOV_{0,c} equals DA₀

Step 4

UC₀=c

And, then the hedging module calculates a derivatives strategy by function 3:

### Function 3—Determine Derivative Replication Points One Month Forward

Calculate EOV_{0,c}(x % forward return) the embedded option value assuming a x % one month return using {S₀} for several x % assumed values (assuming c=UC₀). For example, presuming an initial c=3%, six assumed forward returns would yield seven values for EOV_{0,c}:
1) EOV_{0,c}(c % forward return)
2) EOV_{0,c}(0% forward return)
3) EOV_{0,c}(−2% forward return)
4) EOV_{0,c}(−4% forward return)
5) EOV_{0,c}(−6% forward return)
6) EOV_{0,c}(−8% forward return)
7) EOV_{0,c}(−10% forward return)

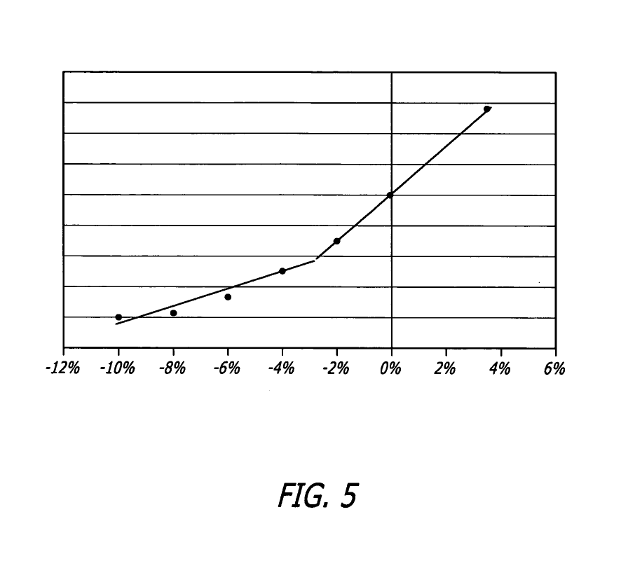

The above values are calculated according to steps 2 and 3 above, with the exception that the hypothetical index return x % is substituted for r_{i,j} in step 2 above. These calculations are then used to define a derivatives strategy that closely replicates the calculated values for EOV_{0,c}. The assets available for investing are DA₀, and the derivatives for investing include futures, options, swaps, money market accounts, deposits, etc. FIG. 5 illustrates an exemplary strategy in which values for the seven assumed forward returns are plotted. The plot of FIG. 5 embodies a derivatives strategy. Each point in FIG. 5 represents a one month forward value of the derivatives strategy. For example, the value of the embedded option one month out if the underlying index rises by 3% or more is EOV_{0,c}(c % forward return). The EOV points are fit to a plot generated by a curve-fitting algorithm, for example, by a sum of the squares error fit algorithm. Hedging assets in the form of a portfolio of derivatives on the underlying index can derived from the plot using any one of a number of publicly available optimizing routines. See, for example, the Solver function available in Microsoft's Excel program. Such a routine may generate a derivatives portfolio including: a money market account having a forecast value equal to EOV_{0,c}(0% forward return); a purchased call option on the underlying index for a forecast value of EOV_{0,c}(c % forward return); a sold put option on the underlying index for a forecast value of EOV_{0,c}(−2% forward return); and a purchased put option on the underlying index for a forecast value of EOV_{0,c}(−10% forward return). The portfolio is acquired, using DA₀ by transmission of one or more orders.

At the end of the first month, that is, when t=1 execute the following:

### Function 1A—Determine New Scenario Set

Assume the market changes month over month by r₁%.

Assuming no other change in economic parameter values (interest rate changes, implied volatility, etc.) occur, then the scenario set {S₀} used in the prior month would still be a scenario set that would closely replicate the embedded one-month European options on the underlying index. In this case, {S₀} will remain the same, implying that forward the calculation EOV_{1,c}(r₁% forward return) will equal the current EOV_{1,c} (assuming c=UC₀). Under these unlikely conditions, the cap c is not changed.

As the assumption of no economic changes is highly unlikely, the cap c may be changed to account for the changes in economic parameter values. At t=1, determine the new scenario set at time, {S₁} that closely replicates the observed market prices for monthly European options at the end of month 1.

### Function 2A—Determine Variance Due to Scenario Set Change

Set UC₁=UC₀

Calculate the Variance Amount (VAₜ) that represents the gain or loss due to the scenario set {S₀} being different from the new scenario set {S₁}:

VA₁=EVO_{1,c}−EVO_{0,c}(r1% forward retum)(using {S₀} (assuming c=UC₁)

{The manager here has the to: 1. change the cap c, keeping principal preservation as the fund objective (positive exit from decision 417 in FIG. 4), or 2. keep the cap c constant, and allow for potential principal decay (negative exit from decision 417 in FIG. 4)).

If there is to be no change to the cap, then proceed to Function 3A below, else proceed to Function 2A.1

### Function 2A.1—Determine New Cap

Step 1. Choose a Particular c for a Starting Point

Step 2.

$${EOV}_{1 , c} = FP \times [ max [ ( min ( {r}_{1} \% , c ) + min ( {r}_{i , 2} , c ) + min ( {r}_{i , 3} , c ) … + min ( {r}_{i , 12} , c ) + 1 ) , 1 ] \times max [ ( min ( {r}_{i , 13} , c ) + min ( {r}_{i , 14 ,} c ) + min ( {r}_{i , 15} , c ) … + min ( {r}_{i , 24} , c ) + 1 ) , 1 ] \times max [ ( min ( {r}_{i , 25} , c ) + min ( {r}_{i , 26} , c ) + min ( {r}_{i , 27} , c ) … + min ( {r}_{i , 36} , c ) + 1 ) , 1 ] \times … \times max [ ( min ( {r}_{i , ( T \times 12 - 11 )} , c ) + min ( {r}_{i , ( T \times 12 - 10 ) ,} c ) + min ( {r}_{i , ( T \times 12 - 9 )} , c ) … + min ( {r}_{i , T \times 12} , c ) + 1 ) , 1 ] - 1 ]$$

Step 3. After EOV_{1,c,i} is calculated for each i; i=1 to N, EOV_{1,c} is defined to equal the average of all EOV_{1,c,i,}; i=1 to N

$${EOV}_{1 , c} = ( \frac{( {EOV}_{1 , c , 1} + {EOV}_{1 , c , 2} + {EOV}_{1 , c , 3} + … + {EOV}_{1 , c , N} ) \times {( 1 + B {Y}_{0} )}^{( T - 1 )}}{N} )$$

Repeat steps 2 and 3 using a different value for c, until

EOV_{1,c}=EOV_{0, UCo}×(1+BY₀)^{(1/12)}

Set UC₁=c

### Function 3A—Determine Derivative Replication Points One Month Forward

Calculate EOV_{1,c}(x % forward return) the embedded option value assuming a x % one month return using {S₁}

for several (six, for example) x % assumed values (assuming c=UC₁)
1) EOV_{1,c}(c % forward return)
2) EOV_{1,c}(0% forward return)
3) EOV_{1,c}(−2% forward return)
4) EOV_{1,c}(−4% forward return)
5) EOV_{1,c}(−6% forward return)
6) EOV_{1,c}(−8% forward return)
7) EOV_{1,c}(−10% forward return)

The above values are calculated as are those in Function 3 above.

These calculations are then used to define a recalculated derivatives strategy that closely replicates the calculated values for EOV_{1,c}. The assets available for investing are DA₀, and the derivatives for investing include futures, options, swaps, money market accounts, deposits, etc. The values may be represented in a plot similar to that of FIG. 5. Hedging assets in the form of a portfolio of derivatives on the underlying index can derived from the plot as explained above to generate a derivatives portfolio

At the end of monthₜ, end of month, calculations are identical to end of month, calculations with (t-1) replacing 0, and t replacing 1. The process continues periodically (for example, month by month) until t=T.

Although the invention has been described with reference to the presently preferred embodiment, it should be understood that various modifications can be made without departing from the spirit of the invention. Accordingly, the invention is limited only by the following claims.

1. A computerized method for managing an indexed mutual fund having a fund principal, comprising:
selecting a fund objective;
determining a time T measured from a mutual fund closing time;
receiving a fund principal amount at the closing time; and,
at an initial time at or after the closing time:
calculating principal fixed assets and hedging assets for the fund such that the sum of the fixed assets and the hedging assets equals the fund principal;
initially calculating a cap for the mutual fund based on derivative assets related to a fund index;
initially calculating a hedging strategy over T based on the initially calculated cap;
transmitting one or more orders for investment of fixed assets in assets having fixed returns; and
transmitting one or more orders for investment of hedging assets in derivatives of the index according to the initially calculated hedging strategy.

2. The method of claim 1, further comprising:
the selected fund objective is to maximize participation in the fund index; and
at a later time following the initial time but before T:
recalculating the cap based on the derivative assets;
recalculating the hedging strategy over T based on the recalculated cap; and
transmitting one or more orders for investment of hedging assets in derivatives of the fund index according to the recalculated hedging strategy.

3. The method of claim 2, further comprising, periodically recalculating the fixed income assets and the hedging assets.

4. The method of claim 1, further comprising:
the selected fund objective is to preserve the fund principal; and
at a later time following the initial time but before T:
recalculating the hedging strategy over T based on the initially calculated cap; and
transmitting one or more orders for investment of hedging assets in derivatives of the fund index according to the recalculated hedging strategy.

5. The method of claim 4, further comprising, periodically recalculating the fixed income assets and the hedging assets.

6. The method of claim 1, further comprising:
in response to the selected fund objective, at a later time following the initial time but before T:
either, recalculating the hedging strategy over T based on the initially calculated cap, and transmitting one or more orders for investment of hedging assets in derivatives of the fund index according to the recalculated hedging strategy;
or, recalculating the cap based on the derivative assets, recalculating the hedging strategy over T based on the recalculated cap, and transmitting one or more orders for investment of a hedging in derivatives of the fund index according to the recalculated hedging strategy.

7. The method of claim 6, further comprising, periodically recalculating the fixed income assets and the hedging assets.

8. The method of claim 1, further comprising:
at a later time following the initial time but before T:
if the selected fund objective is preservation of the fund principal, recalculating the hedging strategy over T based on the initially calculated cap, and transmitting one or more orders for investment of a portion of hedging assets in derivatives of the fund index according to the recalculated hedging strategy; or
if the selected fund objective is to maximize participation in the fund index, recalculating the cap based on the derivative assets, recalculating the hedging strategy over T based on the recalculated cap, and transmitting one or more orders for investment of hedging assets in derivatives of the fund index according to the recalculated hedging strategy.

9. The method of claim 8, further comprising, periodically recalculating the fixed income assets and the hedging assets.

10. A system for managing an indexed mutual fund having a fund principal and a fund objective, comprising:
means for receiving a fund principal amount at a fund closing time; and,
first calculator means for determining fixed assets and hedging assets over a time T such that the sum of the fixed assets and the hedging assets equals the fund principal;
second calculator means for calculating:
a cap for the mutual fund based on derivatives of an index; and
a hedging strategy over the time T based on the cap;
transmitting means for transmitting one or more orders for investment of fixed assets in assets having fixed returns and transmitting one or more orders for investment of hedging assets in derivatives of the index according to the hedging strategy.

11. The system of claim 10, wherein:
the selected fund objective is to maximize participation in the find index; and
the second calculator means is further for, at a later time following the initial time, but before T, recalculating the cap based the derivatives and recalculating the hedging strategy over T based on the recalculated cap; and
the transmitting means is further for transmitting one or more orders for investment of hedging assets in derivatives of the contract index according to the recalculated hedging strategy.

12. The system of claim 1 1, wherein first calculator means is further for periodically recalculating the fixed income assets and the hedging assets.

13. The system of claim 10, further comprising:
the selected fund objective is to preserve the fund principal; and
the second calculator means is further for, at a later time following the initial time, but before T, recalculating the hedging strategy over T based on the cap; and
the transmitting means is further for transmitting one or more orders for investment of hedging assets in derivatives of the contract index according to the recalculated hedging strategy.

14. The system of claim 13, wherein the first calculator means is further for periodically recalculating the fixed income assets and the hedging assets.

15. The system of claim 10, further comprising:
the second calculator is further for, in response to the selected fund objective, at a later time following the initial time but before T:
either, recalculating the hedging strategy over T based on the cap;
or, recalculating the cap based the derivatives and recalculating the hedging strategy over T based on the recalculated cap;
and the transmitting means is further for transmitting one or more orders for investment of hedging assets in derivatives of the contract index according to the recalculated hedging strategy.

16. The system of claim 15, wherein the first calculator means is further for periodically recalculating the fixed income assets and the hedging assets.

17. The system of claim 10, further comprising:
the second calculator means is further for, at a later time following the initial time but before T:
if the selected fund objective is preservation of the fund principal, recalculating the hedging strategy over T based on the cap; or
if the selected find objective is to maximize participation in the fund index, recalculating the cap based the derivatives and recalculating the hedging strategy over T based on the recalculated cap;
and the transmitting means is further for transmitting one or more orders for investment of hedging assets in derivatives of the fund index according to the recalculated hedging strategy.

18. The system of claim 17, wherein the first calculator means is further for periodically recalculating the fixed income assets and the hedging assets.

19. A system for managing an indexed mutual fund having a fund principal at a fund closing time, a fund objective, and a fund period T, comprising:
first calculator means for calculating fixed assets and hedging assets such that the sum of the fixed assets and the hedging assets equals the fund principal;
second calculator means coupled to the first calculator means for calculating during at least one time period ti following fund closing time a cap based on one or more derivatives of a fund index, and a hedging strategy over T based on the cap;
where t<<T, i is an integer, and 0≦i≦T
means coupled to the first and second calculator means for transmitting one or more orders for investment of fixed assets in assets having fixed returns and transmitting one or more orders for investment of hedging assets in derivatives of the fund index according to the hedging strategy.

20. The system of claim 19, wherein, after an initial time period to, and in response to the selected fund objective, the second calculator means is for recalculating the hedging strategy over T based on the cap calculated during to, or is for recalculating the cap and recalculating the hedging strategy over T based on the recalculated cap.
